(19) United States
(12) Patent Application Publication
(10) Pub. No.: US 2026/0073667 A1
(43) Pub. Date: Mar. 12, 2026

(54) PERSONALIZING VISION-LANGUAGE MODELS WITH USER-SPECIFIC CONCEPTS

(71) Applicants: Kfir Aberman, Redwood City, CA (US); Yuval Alaluf, Tel Aviv (IL); Daniel Cohen-Or, Tel Aviv (IL); Sergey Tulyakov, Santa Monica, CA (US)

(72) Inventors: Kfir Aberman, Redwood City, CA (US); Yuval Alaluf, Tel Aviv (IL); Daniel Cohen-Or, Tel Aviv (IL); Sergey Tulyakov, Santa Monica, CA (US)

(21) Appl. No.: 18/830,456

(22) Filed: Sep. 10, 2024

(51) Int. Cl. G06V 10/774; G06F 40/40; G06V 10/72; G06V 10/77; G06V 20/60; G06V 20/70; G06V 40/16

(52) U.S. Cl. CPC G06V 10/774; G06F 40/40; G06V 10/72; G06V 10/7715; G06V 20/60; G06V 20/70; G06V 40/172

(57) ABSTRACT

Described herein are techniques for personalizing vision-language models (VLMs) to understand user-specific concepts, without modifying original model weights. Pre-trained VLMs are augmented with external concept heads that identify user-specific concepts in input images. A concept embedding vector is computed to represent the user-specific concept within an intermediate feature space of the VLM through iterative optimization. Then, when processing an input image and the concept is detected, the concept embedding is appended to image features extracted by a vision encoder of the VLM. Personalized textual outputs incorporating the user-specific concept are generated in response to input images and language instructions. Regularization techniques balance attention between the appended concept embedding and original image features, maintaining alignment between outputs and inputs. This approach enables VLMs to recognize and reason about personalized objects or individuals across diverse settings while preserving general capabilities, enhancing image captioning and visual question-answering with user-specific information.

### TECHNICAL FIELD

The present invention relates generally to the field of artificial intelligence and machine learning, and more particularly to systems and methods for personalizing vision-language models (VLMs) to understand and reason over user-specific concepts. Specifically, the invention pertains to techniques for augmenting pre-trained VLMs with the ability to recognize and incorporate personalized objects or individuals into their outputs without modifying the original model weights, applicable to tasks such as image captioning and visual question-answering.

### BACKGROUND

Large language models (LLMs) have transformed human-computer interaction, offering users intuitive interfaces for interacting with textual information. The integration of vision into LLMs through vision-language models (VLMs) has further enhanced this interaction, enabling these models to “see” and reason over visual content. These models are trained on vast amounts of generic data, allowing them to acquire broad knowledge and capabilities. However, this extensive training on diverse datasets results in VLMs possessing generic knowledge that lacks a personalized understanding of individual users. For example, while a VLM can easily recognize an image of a dog due to its exposure to numerous dog images during training, it lacks the ability to understand that a specific depicted dog is a user's personal pet. This limitation stems from the models'focus on general patterns and concepts rather than user-specific information, highlighting the challenge of incorporating personalized understanding into these powerful yet generalized systems.

### BRIEF DESCRIPTION OF THE DRAWINGS

In the drawings, which are not necessarily drawn to scale, like numerals may describe similar components in different views. To easily identify the discussion of any particular element or operation, the most significant digit or digits in a reference number refer to the figure number in which that element is first introduced. Some non-limiting examples are illustrated in the figures of the accompanying drawings in which:

FIG. 1 is a diagram illustrating the process of personalizing a pre-trained vision-language model (VLM) to understand user-specific concepts, showing both the training and setup stage and the inference stage, consistent with some embodiments.

FIG. 2 is a block diagram depicting the detailed architecture of a personalized VLM system, including components such as the VLM vision encoder, concept heads, and learned concepts, consistent with some embodiments.

FIG. 3 is a flowchart illustrating a method for personalizing a VLM to understand user-specific concepts, including steps for receiving concept images, training concept heads, processing input images, detecting concepts, appending embeddings, and generating personalized outputs.

FIG. 4 is a diagram illustrating a user interface for a digital AI assistant powered by a personalized VLM, showcasing the system's ability to engage in personalized visual conversations.

FIG. 5 is a block diagram illustrating the hardware architecture of a computing device, including processors, memory, storage, and I/O components, consistent with some embodiments.

FIG. 6 is a block diagram depicting the software architecture of a computing device, showing various applications, frameworks, and system components, consistent with some embodiments.

### DETAILED DESCRIPTION

The present disclosure relates to techniques for personalizing vision-language models (VLMs) to understand and reason about user-specific concepts without modifying the original model weights. These techniques aim to enhance human-computer interaction by enabling VLMs to recognize and incorporate personalized objects, individuals, and concepts across diverse visual contexts while maintaining their general capabilities. The following detailed description is presented to enable any person skilled in the art to implement and use the disclosed embodiments. For purposes of explanation, specific technical details are set forth to provide a thorough understanding of the present embodiments. However, it will be apparent to one skilled in the art that the present embodiments may be practiced without these specific details.

VLMs have emerged as powerful tools for processing and reasoning about both textual and visual information, revolutionizing human-computer interaction. These models, trained on vast amounts of generic data, have acquired broad knowledge and impressive capabilities. However, their focus on general patterns and concepts has resulted in an important limitation: the inability to understand and incorporate user-specific concepts. This technical problem poses significant challenges for personalizing VLMs and adapting them to individual users'needs without compromising their general capabilities.

The technical problem lies in personalizing pre-trained VLMs to recognize and reason about user-specific concepts without requiring extensive retraining or compromising their general capabilities. Current VLMs excel at identifying common objects and generating generic descriptions but fail to associate these elements with personal context. For instance, while a VLM can easily recognize a dog in an image, it cannot distinguish that the dog is a user's personal pet. This limitation stems from the models'training on diverse datasets, which results in a focus on general patterns rather than user-specific information.

Attempting to fine-tune these models for each user poses significant technical challenges. The process is computationally expensive, often requiring substantial hardware resources and time. Moreover, fine-tuning is prone to catastrophic forgetting, where the model loses its general knowledge while adapting to specific tasks. This is particularly problematic for VLMs, as their power lies in their ability to understand and generate responses across a wide range of topics and visual scenarios. The sheer size of these models, often containing billions of parameters, makes it impractical to maintain separate personalized versions for each user, both in terms of storage requirements and computational costs.

Existing model editing techniques, developed in the context of large language models, offer limited solutions to this problem. These methods typically focus on altering the model's response to specific user queries, such as changing a factual answer. However, they fall short when it comes to teaching the model to recognize and reason about new visual concepts across diverse contexts. The challenge is not just in recognizing a specific object or person but in understanding its significance to the user and incorporating that understanding into generated responses.

The technical challenge is further compounded by the need to disentangle user-specific concepts from their surroundings. The system must learn to identify the target concept (e.g., a specific individual or object) while ignoring irrelevant details like clothing, background, or lighting conditions. This requires sophisticated feature extraction and representation learning techniques that can capture the essence of the user-specific concept across various appearances and contexts.

Additionally, the personalized VLM must not only identify the concept but also contextualize it within the generated response, producing natural and coherent outputs. This involves complex language generation tasks that must seamlessly integrate the recognized user-specific concepts with the model's general knowledge. The system needs to maintain a delicate balance between leveraging its pre-trained capabilities and incorporating the new, personalized information.

Another critical technical hurdle is maintaining the balance between personalization and the model's general capabilities. The solution must allow for the integration of user-specific knowledge without disrupting the VLM's ability to process and reason about general visual and textual information. This requires careful consideration of how new information is incorporated into the model's existing knowledge structure, potentially necessitating novel architectures or training paradigms that can compartmentalize personal and general knowledge effectively.

The personalization process must also be efficient and scalable to be practical in real-world applications. It should require minimal data and computational resources to adapt to new user-specific concepts, making it feasible to deploy in scenarios where users may frequently introduce new personal concepts. This constraint adds another layer of complexity to the problem, as the system must be able to learn quickly from a small number of examples while still generalizing effectively to new instances of the learned concepts.

Furthermore, the solution must address privacy concerns associated with personalization. As user-specific concepts often involve personal information, the system needs to ensure that this data is handled securely and that the personalized knowledge doesn't leak into responses for other users. This adds security and data isolation requirements to the already complex technical problem.

Lastly, the personalized VLM must be able to handle multiple user-specific concepts simultaneously, potentially from different users. This multi-concept personalization introduces additional challenges in terms of concept representation, retrieval, and integration into the model's outputs. The system needs to efficiently manage and disambiguate between various personal concepts, ensuring that the right concepts are used in the appropriate contexts.

In summary, the technical problem of personalizing VLMs involves a complex interplay of machine learning, computer vision, natural language processing, and system design challenges. It requires innovative solutions that can efficiently integrate user-specific knowledge into powerful pre-trained models while maintaining their general capabilities, ensuring privacy, and providing natural, contextually appropriate responses across a wide range of visual and textual tasks.

The present disclosure sets forth a technical solution to the aforementioned technical problems by introducing what is referred to herein as a personalized VLM, for generating personalized outputs from a pre-trained VLM without modifying its original weights. This innovative approach enables VLMs to “understand” and reason about user-specific concepts while maintaining its general capabilities.

The personalized VLM is based on a modular approach, consisting of several components. First, the personalized VLM augments a pre-trained VLM with external concept heads, which are specialized classifiers trained to identify user-specific concepts within input images. These concept heads operate independently from the VLM, allowing for the recognition of personalized concepts without altering the model's general visual understanding capabilities.

For each user-specific concept, the personalized VLM computes a concept embedding vector that represents the concept within the VLM's intermediate feature space. This embedding is optimized through an iterative process, minimizing the cross-entropy loss between generated captions and target captions for a small set of images depicting the concept. When a user-specific concept is detected in an input image by the concept heads, the personalized VLM appends the corresponding learned concept embedding to the image features extracted by the VLM's vision encoder. This approach allows the model to incorporate personalized information without modifying its original architecture.

To maintain alignment between the generated outputs and input images, the personalized VLM employs regularization techniques. These include normalizing the key and value vectors corresponding to the concept embedding and applying L2 regularization over the attention probabilities assigned to the concept embedding. These techniques help balance the attention between the appended concept embedding and the original image features, ensuring coherent and contextually appropriate outputs.

The personalized VLM can be applied to various VLM architectures, such as BLIP-2 and LLaVA, among others, and supports both personalized image captioning and visual question-answering tasks. For visual question-answering, the system is trained on a set of question-answer pairs related to the user-specific concept, enabling it to generate personalized answers to new questions about the concept in input images.

This solution effectively addresses the key technical challenges by enabling personalization without extensive retraining or modifying the original VLM weights, thus preserving general capabilities while incorporating user-specific knowledge. It efficiently learns to recognize and reason about new concepts with minimal data, typically requiring only 3-5 images per concept. The use of specialized concept heads and learned embeddings allows for the disentanglement of user-specific concepts from their surroundings, while the system generates contextually appropriate and coherent outputs that naturally incorporate personalized concepts. Additionally, the personalized VLM supports multiple user-specific concepts simultaneously, allowing for scalable personalization across various users and concepts.

By leveraging this modular and efficient approach, the personalized VLM enhances the ability of powerful pre-trained VLMs to understand and communicate about user-specific concepts across diverse visual contexts. This solution opens up new possibilities for more meaningful and personalized human-computer interactions in vision-language tasks, paving the way for advanced applications in areas such as personalized image captioning, visual question-answering, and beyond. Other aspects and advantages of the present invention will be readily apparent from the description of the several figures that follow.

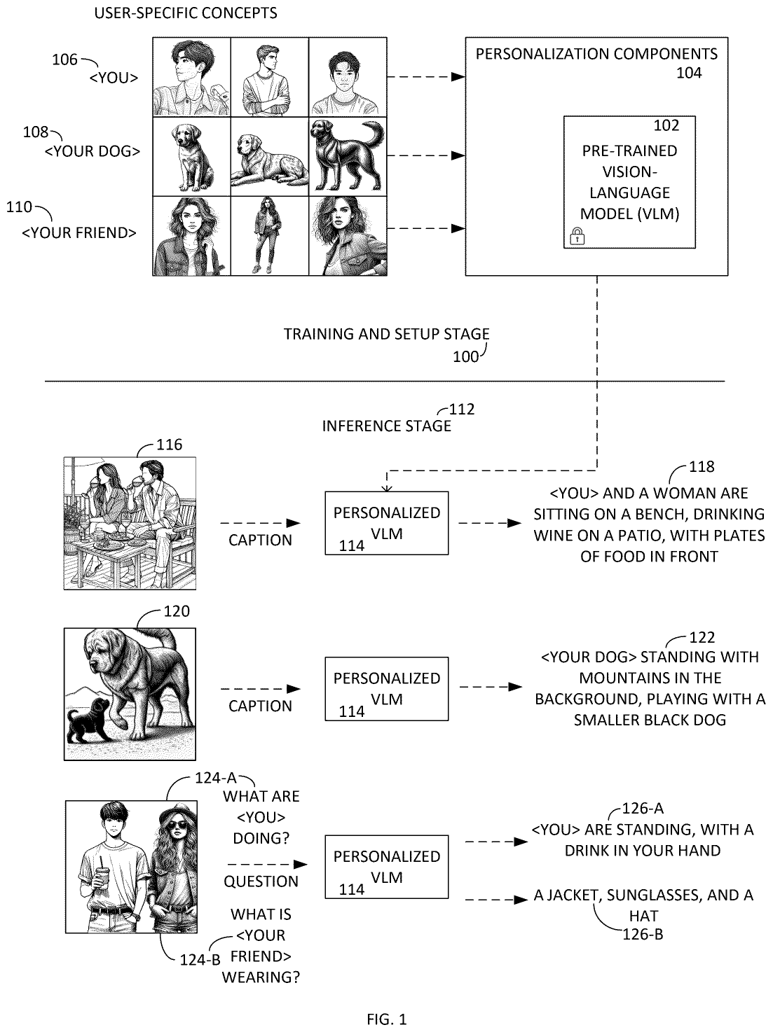

FIG. 1 is a diagram illustrating the process of personalizing a pre-trained VLM to understand user-specific concepts, showing both the training and setup stage 100 and the inference stage 112, consistent with some embodiments. The training and setup stage 100 illustrated in FIG. 1 represents the initial process of personalizing a pre-trained VLM to “understand” user-specific concepts. This stage enables the VLM to recognize and reason about personalized objects, individuals, and concepts across diverse visual contexts. The process begins with the introduction of user-specific concepts, which are represented by three distinct concepts: <YOU> 106, <YOUR DOG> 108, and <YOUR FRIEND> 110. Each user-specific concept is represented by several images depicting the subject in different contexts or poses, allowing the system to learn and recognize the user-specific concepts across various scenarios. These images, along with corresponding captions containing the concept identifiers, are used to train the personalized system, specifically the concept heads and concept embeddings.

As shown in FIG. 1, the personalization component 104 is shown to be separate, but encompass the pre-trained model. The VLM is depicted as a “locked” component, indicating that its original weights remain unchanged during the personalization process. The personalization components 104 encompass both the pre-trained VLM and the additional components that augment it to provide understanding of personal concepts. These components work together to integrate user-specific knowledge into the model without modifying its original architecture or compromising its general capabilities.

The training process involves several steps. For each user-specific concept, an external concept head is trained. These concept heads are specialized classifiers that learn to identify the presence of the specific concept within an input image. Simultaneously, the system computes a concept embedding vector for each user-specific concept, representing the concept within the VLM's intermediate feature space. The system optimizes these embeddings through an iterative process, minimizing the cross-entropy loss between generated captions and target captions for the provided set of images depicting each concept.

To maintain alignment between the generated outputs and input images, the system employs regularization techniques. These include normalizing the key and value vectors corresponding to the concept embeddings and applying L2 regularization over the attention probabilities assigned to the concept embeddings. The training process typically requires only a small set of images (3-5) for each user-specific concept, making it efficient and practical for personalization.

By the end of the training and setup stage, the system has effectively learned to recognize and reason about the user-specific concepts, preparing it for the inference stage 112 where it can generate personalized outputs for new input images. This approach allows the VLM to incorporate personalized knowledge while preserving its general capabilities and without modifying its original architecture, opening up new possibilities for more meaningful and personalized human-computer interactions in vision-language tasks.

The inference stage 112 in FIG. 1 illustrates how the personalized VLM operates from the end user's perspective. This stage demonstrates the system's ability to generate personalized outputs for new input images across various tasks.

In the first example, the input image 116 shows two people sitting on a bench. The overall task is to create a caption for this image. The personalized VLM 114 processes the image and generates a caption 118 that incorporates the user-specific concept, <YOU>, for example, “<YOU> AND A WOMAN ARE SITTING ON A BENCH, DRINKING WINE ON A PATIO, WITH PLATES OF FOOD IN FRONT”. This output demonstrates the system's ability to recognize the user in the image and provide a detailed, personalized description of the scene, including a reference to the user-specific concept.

The second example showcases object recognition and captioning. The input image 120 depicts a dog. The personalized VLM processes this image and generates a caption 122 that recognizes the user's specific dog: “<YOUR DOG> STANDING WITH MOUNTAINS IN THE BACKGROUND, PLAYING WITH A SMALLER BLACK DOG”. This output highlights the system's capability to identify user-specific objects (in this case, the user's dog) and describe their actions and surroundings accurately.

The third example demonstrates the system's proficiency in visual question-answering. An input image 124-A is provided along with a first question: “WHAT ARE DOING?” and “WHAT IS WEARING?”. The Personalized VLM processes the image and questions, generating appropriate answers (126-A and 126-B) for each query. The first answer, “<YOU> ARE STANDING, WITH A DRINK IN YOUR HAND”, shows the system's ability to recognize the user and describe their actions. The second answer, “A JACKET, SUNGLASSES, AND A HAT”, demonstrates the model's capability to identify and describe the attire of a specific individual known to the user, for example, as the user-specific concept <YOUR FRIEND>.

These examples illustrate how the personalized VLM can effectively recognize user-specific concepts (such as the user themselves, their dog, and their friend) in new images and incorporate this personalized knowledge into various vision-language tasks. The system generates contextually appropriate and detailed responses that naturally integrate the user-specific concepts, showcasing its ability to provide meaningful and personalized interactions across different scenarios.

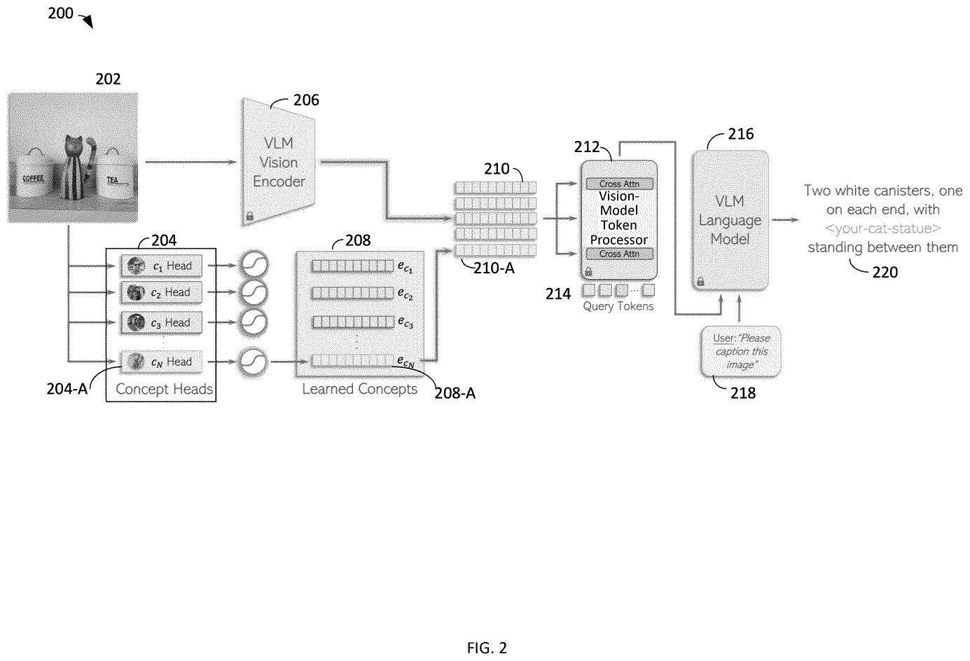

FIG. 2 illustrates the detailed architecture of the personalized VLM system for understanding and generating outputs referring to user-specific concepts. The system processes an input image 202 through several components to generate a personalized textual output 220. The input image 202 in FIG. 2 depicts three objects: two white canisters labeled “COFFEE” and “TEA”, and a cat-shaped figurine standing between them. This image serves as the input to the personalized VLM system.

The caption 220 generated by the system accurately describes the contents of the input image: “Two white canisters, one on each end, with <YOUR CAT-STATUE> standing between them”. This caption 220 demonstrates the system's ability to recognize and describe the general objects in the scene (the white canisters) while also incorporating the user-specific concept (<YOUR CAT-STATUE>) that has been learned through the personalization process. The caption effectively combines the general visual understanding capabilities of the pre-trained VLM with the personalized knowledge of the user's specific cat statue, resulting in a description that is both accurate and tailored to the user's unique concepts.

The process begins with the input image 202 being simultaneously processed by two components: the VLM vision encoder 206 and a set of concept heads 204. The VLM vision encoder extracts general visual features from the input image, represented as a set of image tokens 210 or embeddings. These tokens capture the overall content and structure of the image, including elements such as the white canisters labeled “COFFEE” and “TEA”, and the general shape of the object between them.

In parallel, the concept heads 204 process the input image to identify the presence of specific user-defined concepts. Each concept head (c1, c2, c3, . . . , cN) is a specialized classifier trained to recognize a particular user-specific concept. In this case, the concept head 204-A is specifically trained to recognize the user's cat statue. When processing the input image 202, this concept head 204-A generates an output (represented by the small circle) indicating that the cat statue is indeed present in the image.

Upon detection of the cat statue concept by the concept head 204-A, the system activates the corresponding learned concept 208-A from the set of pre-computed concept embeddings (ec1, ec2, ec3, . . . , ecN). This learned concept embedding represents the user-specific concept of the cat statue within the VLM's intermediate feature space.

The activated concept embedding 208-A is then appended to the image tokens or embeddings 210 output by the vision encoder, creating an augmented set of tokens, including the tokens or embedding 210-A for the user-specific concept, <YOUR CAT-STATUE>. This combination allows the system to integrate both the general visual features of the image and the specific learned representation of the user's cat statue.

This augmented set of tokens is then passed through the vision-language token processor 212, which uses cross-attention mechanisms to process the combined information. The vision-language token processor 212 extracts relevant information from both the general image features 210 and the appended concept embedding 210-A, preparing it for the final stage of processing.

Finally, the output from the vision-language token processor 212, along with the user prompt 218 “Please caption this image”, is fed into the VLM Language Model 216. This model 216 generates the personalized textual output 220: “Two white canisters, one on each end, with standing between them”. This caption 220 accurately describes the image while incorporating the user-specific concept of the cat statue, demonstrating the system's ability to recognize and describe both general objects and personalized concepts within the same image.

This architecture allows the personalized VLM system to recognize user-specific concepts, integrate them with general visual understanding, and generate personalized textual outputs that accurately describe the image while incorporating the user's unique concepts. The modular design enables the system to handle multiple concepts and adapt to new user-specific objects or individuals without modifying the underlying pre-trained VLM.

The system employs regularization techniques to maintain alignment between the generated outputs and input images. These techniques include normalizing the key and value vectors corresponding to the concept embeddings and applying L2 regularization over the attention probabilities assigned to the concept embeddings by query tokens. This ensures a balanced distribution of attention across all tokens and helps prevent the concept embedding from dominating the attention distribution.

By leveraging this architecture, the personalized VLM can effectively personalize pre-trained VLMs to understand and reason about user-specific concepts while preserving the pre-trained model's general capabilities and without modifying its original architecture. This approach opens up new possibilities for more meaningful and personalized human-computer interactions in vision-language tasks.

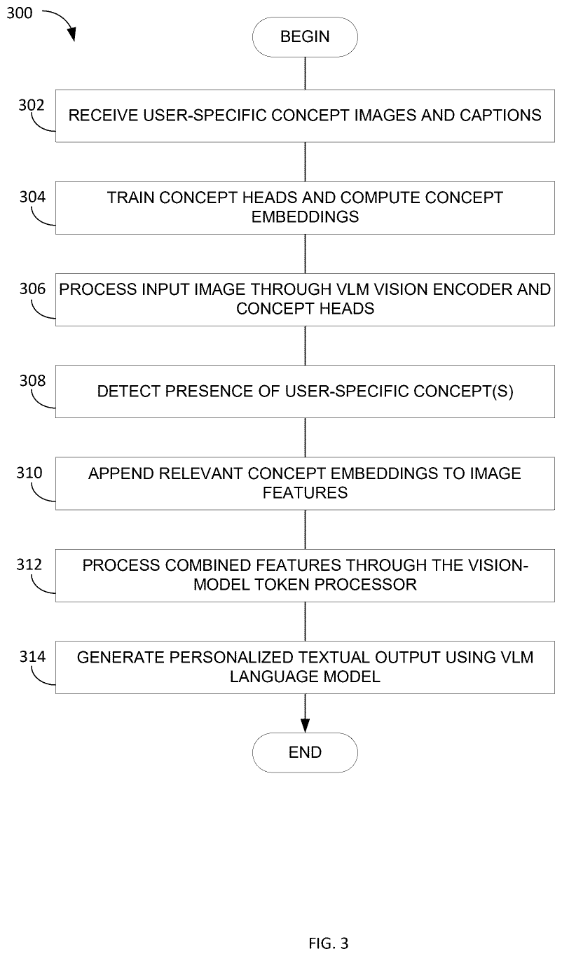

FIG. 3 is a flowchart illustrating a method for personalizing a VLM to understand user-specific concepts, including steps for receiving concept images, training concept heads, processing input images, detecting concepts, appending embeddings, and generating personalized outputs, according to some examples. The method for personalizing a VLM to understand user-specific concepts begins with receiving a set of images depicting user-specific concepts, along with corresponding captions containing concept identifiers 302. These concepts can include individuals (e.g., <YOU>, or <YOUR FRIEND>, <YOUR WIFE>) or objects (e.g., <YOUR CAR>, <YOUR DOG>), each represented by multiple images showcasing the concept in various contexts.

Using this input data, the system trains external concept heads and computes concept embedding vectors 304. The concept heads are specialized classifiers (e.g., machine learning models) designed to identify the presence of specific user-defined concepts within input images. Simultaneously, the system computes concept embedding vectors that represent each user-specific concept within the VLM's intermediate feature space. This process involves optimizing the embeddings to minimize the cross-entropy loss between generated captions and target captions for the provided set of images.

When processing a new input image, the system first passes it through the VLM vision encoder to extract general visual features 306. In parallel, the image is processed by the trained concept heads to identify the presence of any user-specific concepts. This dual processing allows the system to maintain its general visual understanding capabilities while also recognizing personalized elements.

If a user-specific concept is detected by a concept head, the system activates the corresponding learned concept embedding 308. This embedding is then appended to the image features extracted by the VLM vision encoder, creating an augmented set of features that incorporate both general and personalized information.

The augmented feature set is then processed through a series of cross-attention layers in the vision-model token processor 310, which, in some embodiments, may be. This component uses query tokens to extract relevant information from both the general image features and the appended concept embeddings, preparing the data for the final stage of processing.

Finally, the output from the vision-model token processor, along with a user prompt (e.g., “Please caption this image” or a specific question), is fed into the VLM language model 312. This model generates a personalized textual output that incorporates the user-specific concepts while remaining contextually accurate and aligned with the input image.

Throughout this process, the system employs regularization techniques 314 to maintain a balance between the general image features and the personalized concept information. These techniques include normalizing the key and value vectors corresponding to the concept embeddings and applying L2 regularization over the attention probabilities assigned to the concept embeddings.

This method allows for the personalization of VLMs without modifying their original weights, preserving their general capabilities while enabling them to recognize and reason about user-specific concepts across diverse visual contexts. The approach is flexible and can be applied to various VLM architectures, supporting both personalized image captioning and visual question-answering tasks.

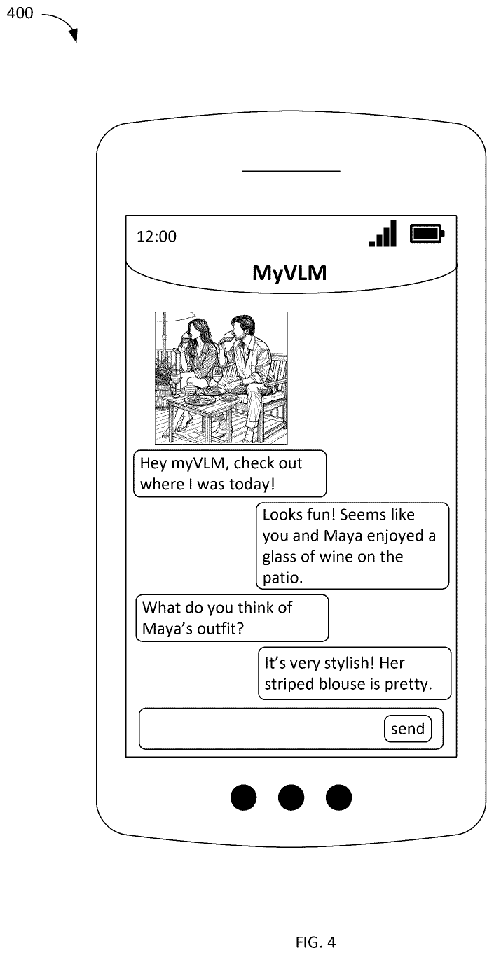

FIG. 4 is a diagram illustrating a user interface for a digital AI assistant powered by a personalized VLM, showcasing the system's ability to engage in personalized visual conversations, consistent with some examples.

The personalized VLM can be effectively utilized in the context of a digital assistant to provide users with a more tailored and context-aware interaction experience. By leveraging the personalized understanding of user-specific concepts, the digital assistant can engage in more meaningful and relevant conversations about the user's personal world.

The user interface in FIG. 4 demonstrates a chat-like interface for a digital assistant, referred to here as “MyVLM”. The interface displays the name “MyVLM” at the top, indicating the personalized nature of the assistant. The main content area shows an image shared by the user, depicting two individuals enjoying drinks at what appears to be an outdoor setting.

The conversation flow in the screenshot illustrates the assistant's ability to understand and respond to user-specific queries:

The user initiates the interaction by sharing an image and asking the assistant to “check out where I was today!”

The MyVLM assistant responds with a personalized observation: “Looks fun! Seems like you and Maya enjoyed some cool cocktails at the bar!” This response demonstrates the system's ability to recognize individuals known to the user (in this case, “Maya”) and provide context-relevant comments.

The user then asks for the assistant's opinion on Maya's outfit, to which MyVLM responds: “It's very stylish! I really like the casual look and the sunglasses!” This interaction showcases the system's capability to analyze specific aspects of the image and provide opinions on user-specified elements.

This example effectively illustrates how the personalized VLM can be integrated into a user-friendly digital assistant interface, enabling natural, context-aware conversations about user-specific content and individuals.

### Machine Architecture

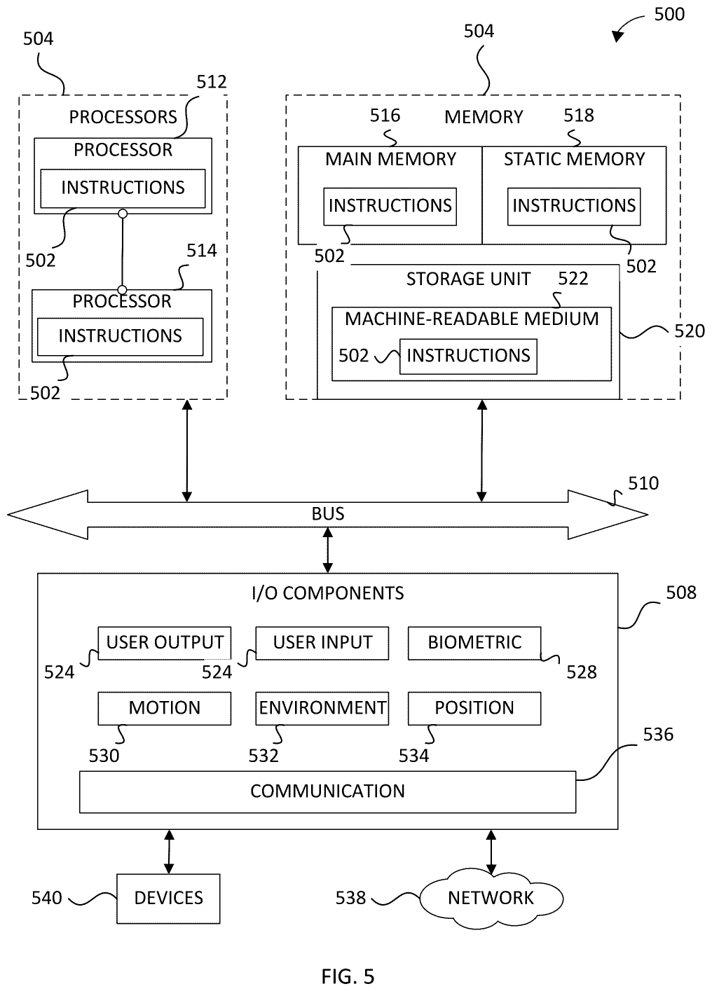

FIG. 5 is a diagrammatic representation of the machine 500 within which instructions 502 (e.g., software, a program, an application, an applet, an app, or other executable code) for causing the machine 500 to perform any one or more of the methodologies discussed herein may be executed. For example, the instructions 502 may cause the machine 500 to execute any one or more of the methods described herein. The instructions 502 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 502, sequentially or otherwise, that specify actions to be taken by the machine 500. Further, while a single machine 500 is illustrated, the term “machine” shall also be taken to include a collection of machines that individually or jointly execute the instructions 502 to perform any one or more of the methodologies discussed herein. The machine 500, for example, may comprise the user system 102 or any one of multiple server devices forming part of the server system 110. In some examples, the machine 500 may also comprise both client and server systems, with certain operations of a particular method or algorithm being performed on the server-side and with certain operations of the method or algorithm being performed on the client-side.

The machine 500 may include processors 504, memory 506, and input/output I/O components 508, which may be configured to communicate with each other via a bus 510.

The memory 506 includes a main memory 516, a static memory 518, and a storage unit 520, both accessible to the processors 504 via the bus 510. The main memory 506, the static memory 518, and storage unit 520 store the instructions 502 embodying any one or more of the methodologies or functions described herein. The instructions 502 may also reside, completely or partially, within the main memory 516, within the static memory 518, within machine-readable medium 522 within the storage unit 520, within at least one of the processors 504 (e.g., within the processor's cache memory), or any suitable combination thereof, during execution thereof by the machine 500.

The I/O components 508 may include a wide variety of components to receive input, provide output, produce output, transmit information, exchange information, capture measurements, and so on. The specific I/O components 508 that are included in a particular machine will depend on the type of machine. For example, portable machines such as mobile phones may include a touch input device or other such input mechanisms, while a headless server machine will likely not include such a touch input device. It will be appreciated that the I/O components 508 may include many other components that are not shown in FIG. 5. In various examples, the I/O components 508 may include user output components 524 and user input components 526. The user output components 524 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 526 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 530 include acceleration sensor components (e.g., accelerometer), gravitation sensor components, rotation sensor components (e.g., gyroscope).

The environmental components 532 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 508 further include communication components 536 operable to couple the machine 500 to a network 538 or devices 540 via respective coupling or connections. For example, the communication components 536 may include a network interface component or another suitable device to interface with the network 538. In further examples, the communication components 536 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 540 may be another machine or any of a wide variety of peripheral devices (e.g., a peripheral device coupled via a USB).

Moreover, the communication components 536 may detect identifiers or include components operable to detect identifiers. For example, the communication components 536 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 536, such as location via Internet Protocol (IP) geolocation, location via Wi-Fi® signal triangulation, location via detecting an NFC beacon signal that may indicate a particular location, and so forth.

The various memories (e.g., main memory 516, static memory 518, and memory of the processors 504) and storage unit 520 may store one or more sets of instructions and data structures (e.g., software) embodying or used by any one or more of the methodologies or functions described herein. These instructions (e.g., the instructions 502), when executed by processors 504, cause various operations to implement the disclosed examples.

The instructions 502 may be transmitted or received over the network 538, using a transmission medium, via a network interface device (e.g., a network interface component included in the communication components 536) and using any one of several well-known transfer protocols (e.g., hypertext transfer protocol (HTTP)). Similarly, the instructions 502 may be transmitted or received using a transmission medium via a coupling (e.g., a peer-to-peer coupling) to the devices 540.

### Software Architecture

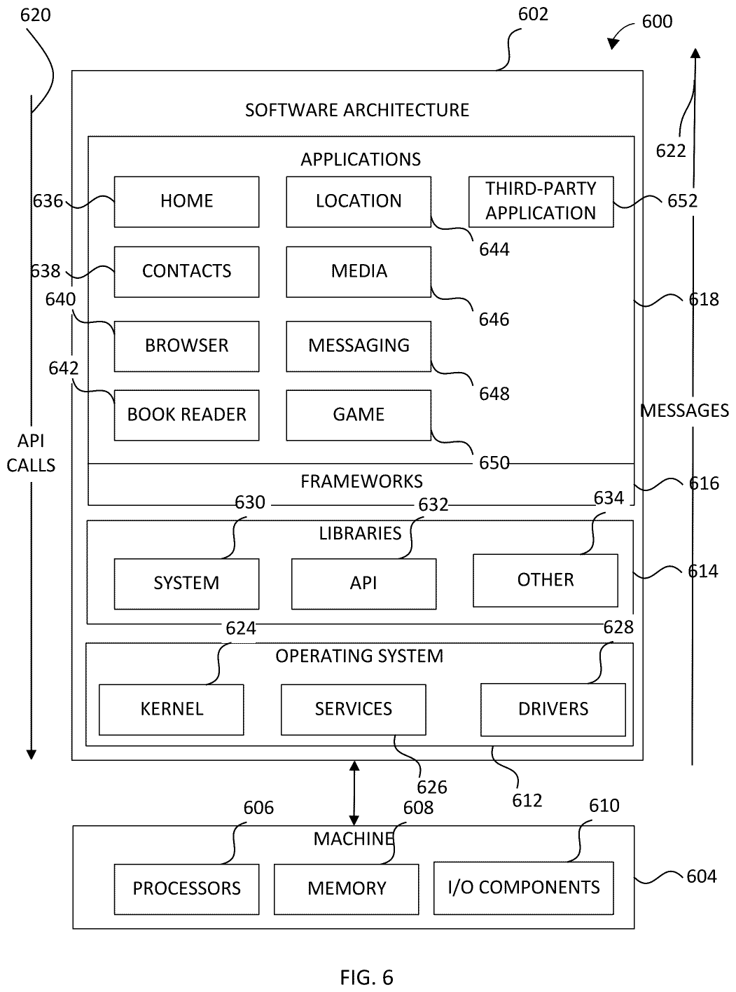

FIG. 6 is a block diagram 600 illustrating a software architecture 602, which can be installed on any one or more of the devices described herein. The software architecture 602 is supported by hardware such as a machine 604 that includes processors 606, memory 608, and I/O components 610. In this example, the software architecture 602 can be conceptualized as a stack of layers, where each layer provides a particular functionality. The software architecture 602 includes layers such as an operating system 612, libraries 614, frameworks 616, and applications 618. Operationally, the applications 618 invoke API calls 620 through the software stack and receive messages 622 in response to the API calls 620.

The operating system 612 manages hardware resources and provides common services. The operating system 612 includes, for example, a kernel 624, services 626, and drivers 628. The kernel 624 acts as an abstraction layer between the hardware and the other software layers. For example, the kernel 624 provides memory management, processor management (e.g., scheduling), component management, networking, and security settings, among other functionalities. The services 626 can provide other common services for the other software layers. The drivers 628 are responsible for controlling or interfacing with the underlying hardware. For instance, the drivers 628 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 614 provide a common low-level infrastructure used by the applications 618. The libraries 614 can include system libraries 630 (e.g., C standard library) that provide functions such as memory allocation functions, string manipulation functions, mathematical functions, and the like. In addition, the libraries 614 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 614 can also include a wide variety of other libraries 634 to provide many other APIs to the applications 618.

The frameworks 616 provide a common high-level infrastructure that is used by the applications 618. For example, the frameworks 616 provide various graphical user interface (GUI) functions, high-level resource management, and high-level location services. The frameworks 616 can provide a broad spectrum of other APIs that can be used by the applications 618, some of which may be specific to a particular operating system or platform.

In an example, the applications 618 may include a home application 636, a contacts application 638, a browser application 640, a book reader application 642, a location application 644, a media application 646, a messaging application 648, a game application 650, and a broad assortment of other applications such as a third-party application 652. The applications 618 are programs that execute functions defined in the programs. Various programming languages can be employed to create one or more of the applications 618, structured in a variety of manners, such as object-oriented programming languages (e.g., Objective-C, Java, or C++) or procedural programming languages (e.g., C or assembly language). In a specific example, the third-party application 652 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 652 can invoke the API calls 620 provided by the operating system 612 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLES

Example 1 is a method for personalizing a vision-language model (VLM) to understand user-specific concepts, the method comprising: receiving a set of images depicting a user-specific concept and corresponding captions containing a concept identifier; augmenting the VLM with an external concept head trained to identify the presence of the user-specific concept within an input image; computing a concept embedding vector representing the user-specific concept within an intermediate feature space of the VLM; appending the computed concept embedding vector to one or more image features extracted by a vision encoder of the VLM when the concept head identifies the presence of the user-specific concept in an input image; and generating a personalized textual output incorporating the user-specific concept in response to the input image and a language instruction.

In Example 2, the subject matter of Example 1 includes, applying regularization to balance attention between the appended concept embedding and the one or more image features to maintain alignment between the generated output and the input image.

In Example 3, the subject matter of Examples 1-2 includes, wherein the concept head comprises: a linear classifier trained on embeddings extracted from a pretrained CLIP model for identifying user-specific objects; and a pretrained face recognition network for identifying user-specific individuals.

In Example 4, the subject matter of Examples 1-3 includes, normalizing key and value vectors corresponding to the concept embedding to match the average norm of the original keys and values in the cross-attention layers of the VLM; and applying L2 regularization over the attention probabilities assigned to the concept embedding by query tokens to encourage a balanced distribution of attention across all tokens.

In Example 5, the subject matter of Examples 1-4 includes, adapting the method for personalized image captioning by: defining a set of target captions related to the user-specific concept; randomly sampling one target caption during each optimization step when training the concept embedding; generating personalized captions for new images containing the user-specific concept by: detecting the presence of the user-specific concept in the input image using the concept head; appending the computed concept embedding to the image features extracted by the vision encoder; using the appended features to guide the VLM in generating a caption that incorporates the user-specific concept; and adjusting the generated caption based on attention weights to emphasize descriptions of image regions corresponding to the user-specific concept.

In Example 6, the subject matter of Examples 1-5 includes, adapting the method for visual question-answering by: defining a set of question-answer pairs related to the user-specific concept; randomly sampling one question-answer pair during each optimization step when training the concept embedding; and generating personalized answers to new questions about the user-specific concept in input images.

In Example 7, the subject matter of Examples 1-6 includes, wherein learning the concept embedding vector comprises: optimizing the concept embedding vector to minimize a cross-entropy loss between a generated caption and a provided target caption for each image in the set of images depicting the user-specific concept; and iteratively adjusting the concept embedding vector to improve its ability to guide the VLM in incorporating the concept identifier into generated outputs.

In Example 8, the subject matter of Examples 1-7 includes, supporting multiple user-specific concepts within a single VLM by: maintaining separate concept heads and concept embedding vectors for each user-specific concept; identifying the presence of multiple concepts in a single input image; and appending multiple concept embedding vectors to the image features when generating personalized textual outputs.

Example 9 is a system for personalizing a vision-language model (VLM) to understand user-specific concepts, the system comprising: at least one processor; at least one memory storage device storing instructions thereon, which, when executed by the at least one processor, cause the system to perform operations comprising: receiving a set of images depicting a user-specific concept and corresponding captions containing a concept identifier; augmenting the VLM with an external concept head trained to identify the presence of the user-specific concept within an input image; computing a concept embedding vector representing the user-specific concept within an intermediate feature space of the VLM; appending the computed concept embedding vector to one or more image features extracted by a vision encoder of the VLM when the concept head identifies the presence of the user-specific concept in an input image; and generating a personalized textual output incorporating the user-specific concept in response to the input image and a language instruction.

In Example 10, the subject matter of Example 9 includes, wherein the operations further comprise: applying regularization to balance attention between the appended concept embedding and the one or more image features to maintain alignment between the generated output and the input image.

In Example 11, the subject matter of Examples 9-10 includes, wherein the concept head comprises: a linear classifier trained on embeddings extracted from a pretrained CLIP model for identifying user-specific objects; and a pretrained face recognition network for identifying user-specific individuals.

In Example 12, the subject matter of Examples 9-11 includes, wherein the operations further comprise: normalizing key and value vectors corresponding to the concept embedding to match the average norm of the original keys and values in the VLM's cross-attention layers; and applying L2 regularization over the attention probabilities assigned to the concept embedding by query tokens to encourage a balanced distribution of attention across all tokens.

In Example 13, the subject matter of Examples 9-12 includes, wherein the operations further comprise: adapting the system for personalized image captioning by: defining a set of target captions related to the user-specific concept; randomly sampling one target caption during each optimization step when training the concept embedding; generating personalized captions for new images containing the user-specific concept by: detecting the presence of the user-specific concept in the input image using the concept head; appending the computed concept embedding to the image features extracted by the vision encoder; using the appended features to guide the VLM in generating a caption that incorporates the user-specific concept; and adjusting the generated caption based on attention weights to emphasize descriptions of image regions corresponding to the user-specific concept.

In Example 14, the subject matter of Examples 9-13 includes, wherein the operations further comprise: adapting the system for visual question-answering by: defining a set of question-answer pairs related to the user-specific concept; randomly sampling one question-answer pair during each optimization step when training the concept embedding; and generating personalized answers to new questions about the user-specific concept in input images.

In Example 15, the subject matter of Examples 9-14 includes, wherein computing the concept embedding vector comprises: optimizing the concept embedding vector to minimize a cross-entropy loss between a generated caption and a provided target caption for each image in the set of images depicting the user-specific concept; and iteratively adjusting the concept embedding vector to improve its ability to guide the VLM in incorporating the concept identifier into generated outputs.

In Example 16, the subject matter of Examples 9-15 includes, supporting multiple user-specific concepts within a single VLM by: maintaining separate concept heads and concept embedding vectors for each user-specific concept; identifying the presence of multiple concepts in a single input image; and appending multiple concept embedding vectors to the image features when generating personalized textual outputs.

Example 17 is a system for personalizing a vision-language model (VLM) to understand user-specific concepts, the system comprising: means for receiving a set of images depicting a user-specific concept and corresponding captions containing a concept identifier; means for augmenting the VLM with an external concept head trained to identify the presence of the user-specific concept within an input image; means for computing a concept embedding vector representing the user-specific concept within an intermediate feature space of the VLM; means for appending the computed concept embedding vector to one or more image features extracted by a vision encoder of the VLM when the concept head identifies the presence of the user-specific concept in an input image; and means for generating a personalized textual output incorporating the user-specific concept in response to the input image and a language instruction.

In Example 18, the subject matter of Example 17 includes, means for applying regularization to balance attention between the appended concept embedding and the one or more image features to maintain alignment between the generated output and the input image.

In Example 19, the subject matter of Examples 17-18 includes, wherein the means for augmenting the VLM with an external concept head comprises: means for implementing a linear classifier trained on embeddings extracted from a pretrained CLIP model for identifying user-specific objects; and means for implementing a pretrained face recognition network for identifying user-specific individuals.

In Example 20, the subject matter of Examples 17-19 includes, means for normalizing key and value vectors corresponding to the concept embedding to match the average norm of the original keys and values in the VLM's cross-attention layers; and means for applying L2 regularization over the attention probabilities assigned to the concept embedding by query tokens to encourage a balanced distribution of attention across all tokens.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components, also referred to as “computer-implemented.” Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A method for personalizing a vision-language model (VLM) to understand user-specific concepts, the method comprising:
receiving a set of images depicting a user-specific concept and corresponding captions containing a concept identifier;
augmenting the VLM with an external concept head trained to identify the presence of the user-specific concept within an input image;
computing a concept embedding vector representing the user-specific concept within an intermediate feature space of the VLM;
appending the computed concept embedding vector to one or more image features extracted by a vision encoder of the VLM when the concept head identifies the presence of the user-specific concept in an input image; and
generating a personalized textual output incorporating the user-specific concept in response to the input image and a language instruction.

2. The method of claim 1, further comprising:
applying regularization to balance attention between the appended concept embedding and the one or more image features to maintain alignment between the generated output and the input image.

3. The method of claim 1, wherein the concept head comprises:
a linear classifier trained on embeddings extracted from a pretrained CLIP model for identifying user-specific objects; and
a pretrained face recognition network for identifying user-specific individuals.

4. The method of claim 1, further comprising:
normalizing key and value vectors corresponding to the concept embedding to match the average norm of the original keys and values in the cross-attention layers of the VLM; and
applying L2 regularization over the attention probabilities assigned to the concept embedding by query tokens to encourage a balanced distribution of attention across all tokens.

5. The method of claim 1, further comprising:
adapting the method for personalized image captioning by:
defining a set of target captions related to the user-specific concept;
randomly sampling one target caption during each optimization step when training the concept embedding;
generating personalized captions for new images containing the user-specific concept by:
detecting the presence of the user-specific concept in the input image using the concept head;
appending the computed concept embedding to the image features extracted by the vision encoder;
using the appended features to guide the VLM in generating a caption that incorporates the user-specific concept; and
adjusting the generated caption based on attention weights to emphasize descriptions of image regions corresponding to the user-specific concept.

6. The method of claim 1, further comprising:
adapting the method for visual question-answering by:
defining a set of question-answer pairs related to the user-specific concept;
randomly sampling one question-answer pair during each optimization step when training the concept embedding; and
generating personalized answers to new questions about the user-specific concept in input images.

7. The method of claim 1, wherein learning the concept embedding vector comprises:
optimizing the concept embedding vector to minimize a cross-entropy loss between a generated caption and a provided target caption for each image in the set of images depicting the user-specific concept; and
iteratively adjusting the concept embedding vector to improve its ability to guide the VLM in incorporating the concept identifier into generated outputs.

8. The method of claim 1, further comprising:
supporting multiple user-specific concepts within a single VLM by:
maintaining separate concept heads and concept embedding vectors for each user-specific concept;
identifying the presence of multiple concepts in a single input image; and
appending multiple concept embedding vectors to the image features when generating personalized textual outputs.

9. A system for personalizing a vision-language model (VLM) to understand user-specific concepts, the system comprising:
at least one processor;
at least one memory storage device storing instructions thereon, which, when executed by the at least one processor, cause the system to perform operations comprising:
receiving a set of images depicting a user-specific concept and corresponding captions containing a concept identifier;
augmenting the VLM with an external concept head trained to identify the presence of the user-specific concept within an input image;
computing a concept embedding vector representing the user-specific concept within an intermediate feature space of the VLM;
appending the computed concept embedding vector to one or more image features extracted by a vision encoder of the VLM when the concept head identifies the presence of the user-specific concept in an input image; and
generating a personalized textual output incorporating the user-specific concept in response to the input image and a language instruction.

10. The system of claim 9, wherein the operations further comprise:
applying regularization to balance attention between the appended concept embedding and the one or more image features to maintain alignment between the generated output and the input image.

11. The system of claim 9, wherein the concept head comprises:
a linear classifier trained on embeddings extracted from a pretrained CLIP model for identifying user-specific objects; and
a pretrained face recognition network for identifying user-specific individuals.

12. The system of claim 9, wherein the operations further comprise:
normalizing key and value vectors corresponding to the concept embedding to match the average norm of the original keys and values in the VLM's cross-attention layers; and
applying L2 regularization over the attention probabilities assigned to the concept embedding by query tokens to encourage a balanced distribution of attention across all tokens.

13. The system of claim 9, wherein the operations further comprise:
adapting the system for personalized image captioning by:
defining a set of target captions related to the user-specific concept;
randomly sampling one target caption during each optimization step when training the concept embedding;
generating personalized captions for new images containing the user-specific concept by:
detecting the presence of the user-specific concept in the input image using the concept head;
appending the computed concept embedding to the image features extracted by the vision encoder;
using the appended features to guide the VLM in generating a caption that incorporates the user-specific concept; and
adjusting the generated caption based on attention weights to emphasize descriptions of image regions corresponding to the user-specific concept.

14. The system of claim 9, wherein the operations further comprise:
adapting the system for visual question-answering by:
defining a set of question-answer pairs related to the user-specific concept;
randomly sampling one question-answer pair during each optimization step when training the concept embedding; and
generating personalized answers to new questions about the user-specific concept in input images.

15. The system of claim 9, wherein computing the concept embedding vector comprises:
optimizing the concept embedding vector to minimize a cross-entropy loss between a generated caption and a provided target caption for each image in the set of images depicting the user-specific concept; and
iteratively adjusting the concept embedding vector to improve its ability to guide the VLM in incorporating the concept identifier into generated outputs.

16. The system of claim 9, further comprising:
supporting multiple user-specific concepts within a single VLM by:
maintaining separate concept heads and concept embedding vectors for each user-specific concept;
identifying the presence of multiple concepts in a single input image; and
appending multiple concept embedding vectors to the image features when generating personalized textual outputs.

17. A system for personalizing a vision-language model (VLM) to understand user-specific concepts, the system comprising:
means for receiving a set of images depicting a user-specific concept and corresponding captions containing a concept identifier;
means for augmenting the VLM with an external concept head trained to identify the presence of the user-specific concept within an input image;
means for computing a concept embedding vector representing the user-specific concept within an intermediate feature space of the VLM;
means for appending the computed concept embedding vector to one or more image features extracted by a vision encoder of the VLM when the concept head identifies the presence of the user-specific concept in an input image; and
means for generating a personalized textual output incorporating the user-specific concept in response to the input image and a language instruction.

18. The system of claim 17, further comprising:
means for applying regularization to balance attention between the appended concept embedding and the one or more image features to maintain alignment between the generated output and the input image.

19. The system of claim 17, wherein the means for augmenting the VLM with an external concept head comprises:
means for implementing a linear classifier trained on embeddings extracted from a pretrained CLIP model for identifying user-specific objects; and
means for implementing a pretrained face recognition network for identifying user-specific individuals.

20. The system of claim 17, further comprising:
means for normalizing key and value vectors corresponding to the concept embedding to match the average norm of the original keys and values in the VLM's cross-attention layers; and
means for applying L2 regularization over the attention probabilities assigned to the concept embedding by query tokens to encourage a balanced distribution of attention across all tokens.
